(19) United States
(12) Patent Application Publication
(10) Pub. No.: US 2013/0174966 A1
(43) Pub. Date: Jul. 11, 2013

(54) MOLDING METHOD OF A HEAT PIPE FOR CAPILLARY STRUCTURE WITH CONTROLLABLE SINTERING POSITION

(71) Applicants: Sin-Wei He, Hsinchu County (TW); Jhong-Yan Chang, Hsinchu City (TW); Yen-Chen Chen, Taichung City (TW)

(72) Inventors: Sin-Wei He, Hsinchu County (TW); Jhong-Yan Chang, Hsinchu City (TW); Yen-Chen Chen, Taichung City (TW)

(73) Assignee: FORCECON TECHNOLOGY CO., LTD., Chu Pei City (TW)

(21) Appl. No.: 13/348,161

(22) Filed: Jan. 11, 2012

(51) Int. Cl. C03B 29/00

(52) U.S. Cl. 156/89.11

(57) ABSTRACT

A molding method of the heat pipe for capillary structure with controllable sintering position wherein said heat pipe is fabricated by said pipe body, grid-sintered composite capillary structure, core rod, evaporation section sintered capillary structure and powder limiting grid. This allows fabrication of the evaporation section sintered capillary structure with the help of the powder limiting grid, such that the capillary structure could be molded more easily while controlling accurately the sintering position and range. Moreover, with embedding of said grid-sintered composite capillary structure, the steam flow channel of the heat pipe could be further expanded and adapted to the flexible processing of the pipe wall, thus facilitating the fabrication and improving the vaporization efficiency of the working fluid with better applicability and industrial benefits.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a molding method of a heat pipe, and more particularly to an innovative one which allows control of the sintering position of capillary structure, expansion of the steam flow channel, and adaptation to the pipe wall processing and facilitation of the fabrication for improved vaporization efficiency of working fluid.

2. Description of Related Art Including Information Disclosed Under 37 CFR 1.97 and 37 CFR 1.98.

The common heat tube is structurally designed with a composite capillary structure to enhance its thermal conductivity. However, despite the improved thermal conductivity of heat pipe with introduction of such composite capillary structure, some problems remain unchanged with varying space configurations of the heat pipe.

There is a growing trend that thin-profile, compact heat pipes are developed in response to lightweight, thin-profile computer and electronic equipments. However, some problems will be encountered by the composite capillary structure preset into the inner space of the heat pipe, owing to the fact that, as for fabrication of the composite capillary structure of the common heat pipe, a core rod is generally inserted into the heat pipe as a fixture, then metal powder is filled into the gap between the core rod and heat pipe wall and finally sintered into a fixed body. However, it is found during actual fabrication that the metal powder could not get thinner in the powder filling process due to extremely small gap. Further, it is difficult to compact the powder with the growing length of the heat pipe. Once the powder sintered body becomes thicker, the steam flow channel is insufficient, in particular when the cross section of the heat pipe becomes smaller to some extent that the powder sintered body occupies a relatively bigger cross section.

Another problem for common heat pipe's composite capillary structure is that, if the powder sintered body and the grid are sintered onto the heat pipe, the flexibility is almost lost. When the heat pipe is pressed into a flat or a bent pipe, the corresponding composite capillary structure could not be adapted flexibly, so the composite capillary structure is disengaged from the heat pipe wall. This phenomenon will lead to blocking or jamming of the steam flow channel, thus affecting seriously the flow smoothness of working fluid and the heat-dissipation efficiency of the heat pipe.

On the other hand, the shortcoming of the structural design of common heat pipe is that, it is difficult to control the sintering position of the internal capillary structure. No matter if the capillary structure is made of metal powder or grid, inaccurate control of the sintering position will lead to serious displacement error, so only global configuration is allowed. Some technical bottlenecks and problems have to be addressed for the intended partial configuration.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the unique molding method of the “heat pipe for capillary structure with controllable sintering position” wherein said heat pipe is fabricated by said pipe body, grid-sintered composite capillary structure, core rod, evaporation section sintered capillary structure and powder limiting grid, this allows fabrication of the evaporation section sintered capillary structure with the help of the powder limiting grid, such that the capillary structure could be molded more easily while controlling accurately the sintering position and range. Moreover, with embedding of said grid-sintered composite capillary structure, the steam flow channel of the heat pipe could be further expanded and adapted to the flexible processing of the pipe wall, thus facilitating the fabrication and improving the vaporization efficiency of the working fluid with better applicability and industrial benefits.

Based on the ultra-thin design of the composite capillary structure of 0.2 mm-0.8 mm in response to the compact heat pipe, the thin-profile inner space of the heat pipe could provide sufficient steam flow space for efficient capillary transmission of working fluid.

Based on the structural design wherein the evaporation section sintered capillary structure is set into a circular pattern, this could expand the dispersion area of the working fluid returned to the evaporation section, and improve the vaporization efficiency of the working fluid at the evaporation section and the heat-dissipation efficiency of the heat pipe.

Based on the structural design wherein a filling limiter for metal powder is formed by the powder limiting grid, so when a longer heat pipe is required, the sintering position of the metal powder could be located close to the opening of the heat pipe (semi-finished state) with the setting of said powder limiting grid, thus improving the acceptability and convenience in the sintering process of the heat pipe metal powder.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an assembled sectional view of the preferred embodiment of the present invention.

FIG. 2 is an exploded perspective view of the preferred embodiment of the present invention.

FIG. 3 is a B-B sectional view of FIG. 1.

FIG. 4 is a C-C sectional view of FIG. 1.

FIG. 5 is a partially enlarged view of the grid-sintered composite capillary structure of the present invention.

FIG. 6 is a schematic view of the present invention wherein the sintered powder layer is set at two lateral surfaces of the metal grid.

FIG. 7 is a schematic view of the present invention wherein the grid-sintered composite capillary structure and the vacuum pipe body are sintered securely.

FIG. 8 is a schematic view of present invention showing the molding method of the heat pipe.

FIG. 9 is another schematic view of the present invention showing the configuration state of the evaporation section sintered capillary structure.

### DETAILED DESCRIPTION OF THE INVENTION

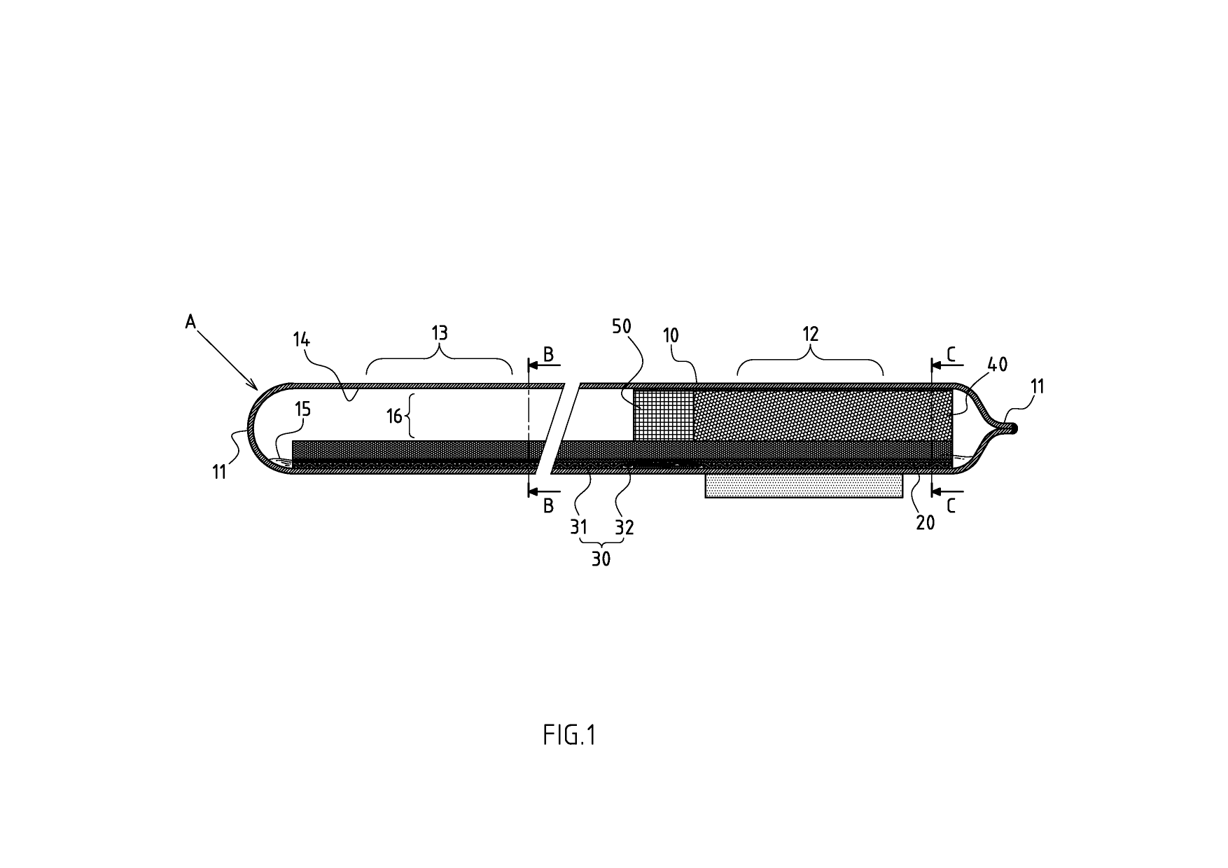

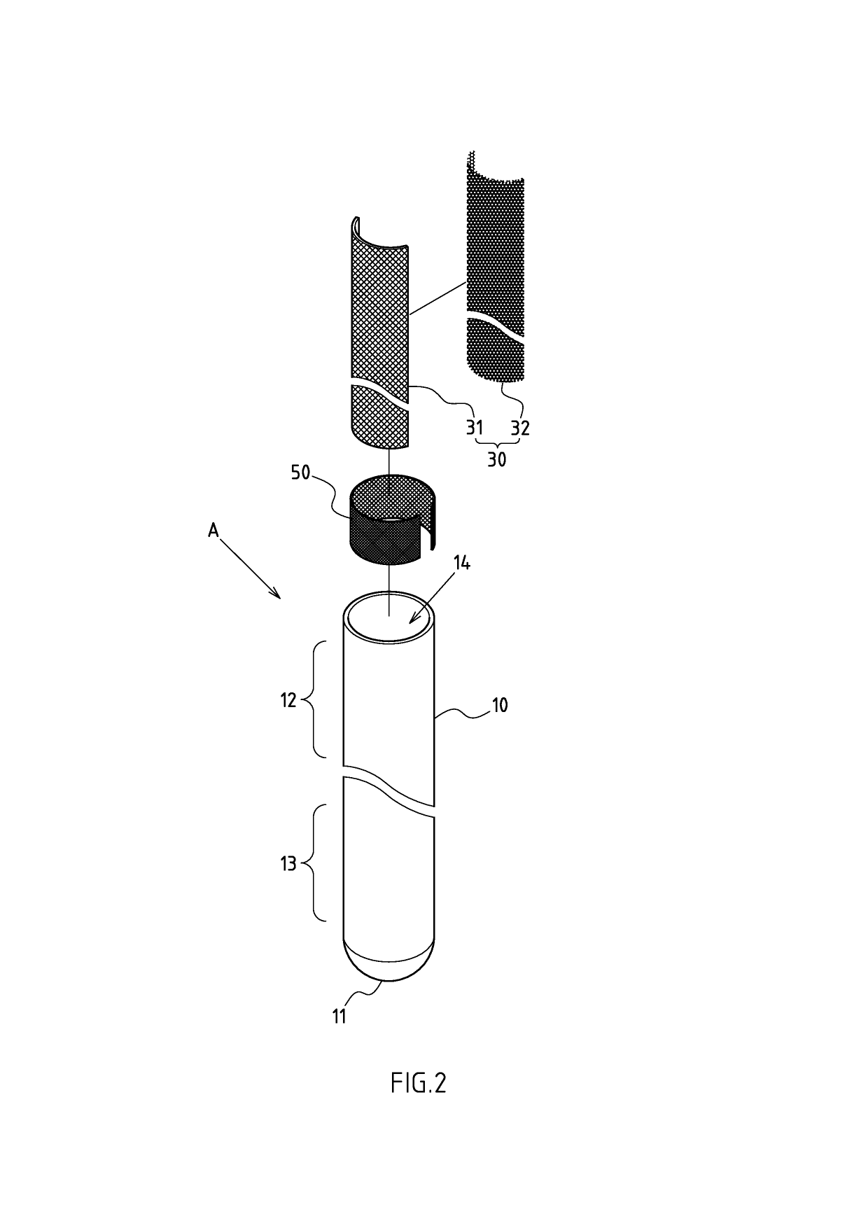

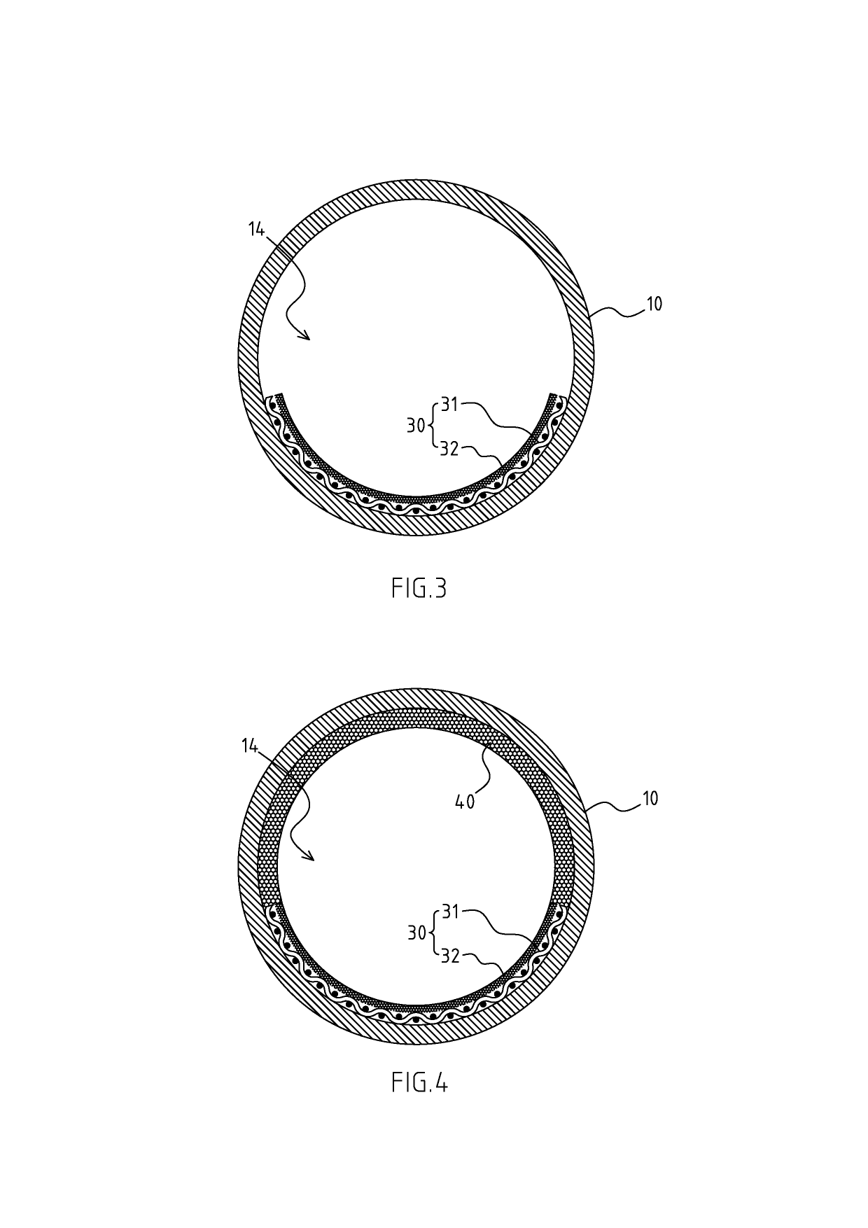

FIGS. 1-5 depict preferred embodiments of the molding method of heat pipe of the present invention for capillary structure with controllable sintering position, which, however, are provided for only explanatory objective for patent claims.

Said heat pipe A comprises a pipe body 10, which is an air-tight hollow pipe body with two closed ends 11, and divided into evaporation section 12 and condensation section 13 according to the heat-dissipation functions. Moreover, the inner space 14 of the pipe body 10 is vacuumed and filled with working fluid 15 (only marked in FIG. 1).

An evaporation section sintered capillary structure 20 is set at the evaporation section 12 of the pipe body 10, and fabricated by at least the metal powder 40 sintered onto inner wall of the evaporation section 12.

An embedded grid-sintered composite capillary structure 30 is set at the condensation section 13 of the pipe body 10, and comprised of a metal grid 31 and at least a sintered powder layer 32. Of which, referring to FIG. 5, the metal grid 31 is of planar grid pattern made of woven metal wires 311. The metal grid 31 comprises of two lateral surfaces. The sintered powder layer 32 is pre-sintered onto at least a lateral surface of the metal grid 31 from the metal powder 40, then the grid-sintered composite capillary structure 30 is placed into the inner space 14 of the pipe body 10. The grid-sintered composite capillary structure 30 still presents flexibility.

A powder limiting grid 50 is set at one end of the evaporation section sintered capillary structure 20, connected or overlapped or mated with the grid-sintered composite capillary structure 30, such that the working fluid 15 cooled down at the condensation section 13 is conveyed to the evaporation section 12. Said powder limiting grid 50 is of a ringed or non-ringed C pattern.

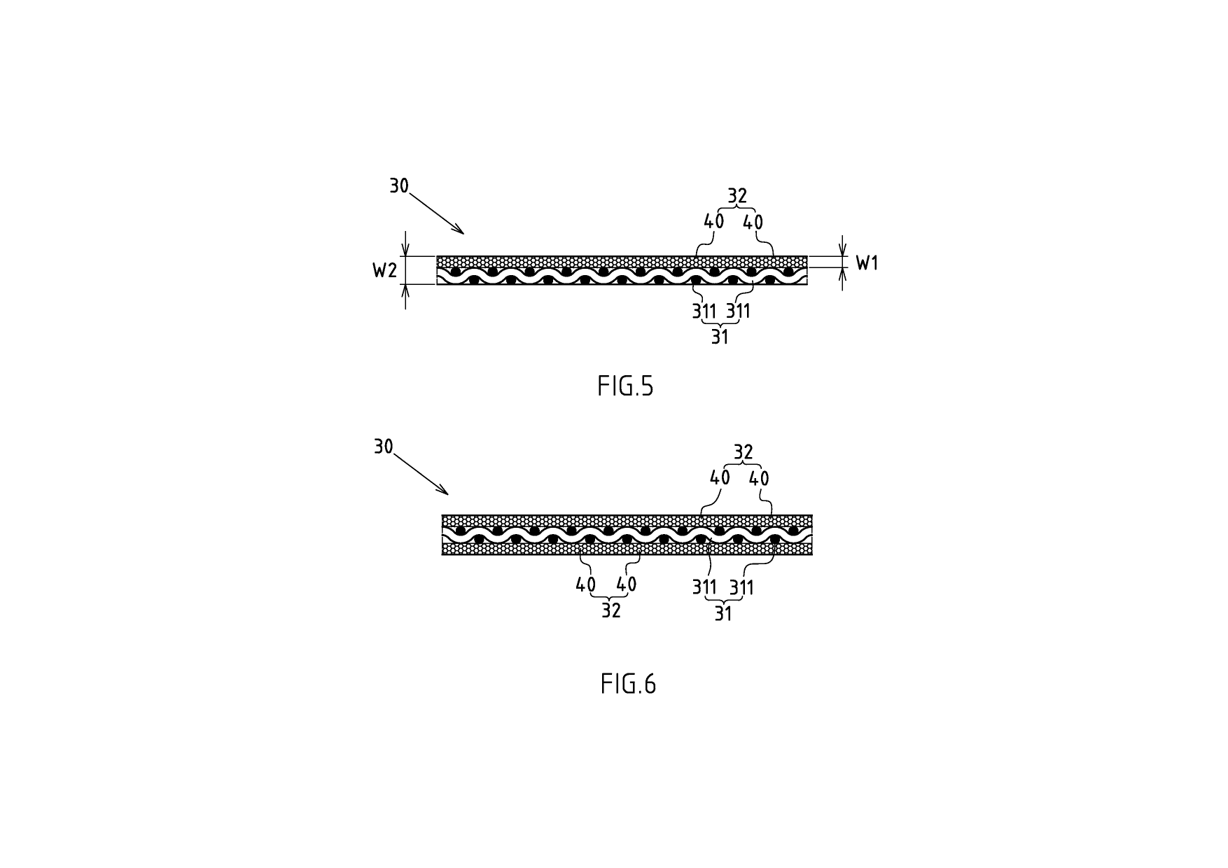

Referring to FIG. 5, the sintered powder layer 32 is set onto a lateral surface of the metal grid 31. Referring also to FIG. 6, the sintered powder layer 32 is set onto two lateral surfaces of the metal grid 31.

Referring to FIG. 5, the grid-sintered composite capillary structure 30 is connected or overlapped or mated with the evaporation section sintered capillary structure 20, of which the thickness W1 of the sintered powder layer 32 is 0.1 mm-0.7 mm, so the total thickness W2 of the grid-sintered composite capillary structure 30 is 0.2 mm-0.8 mm.

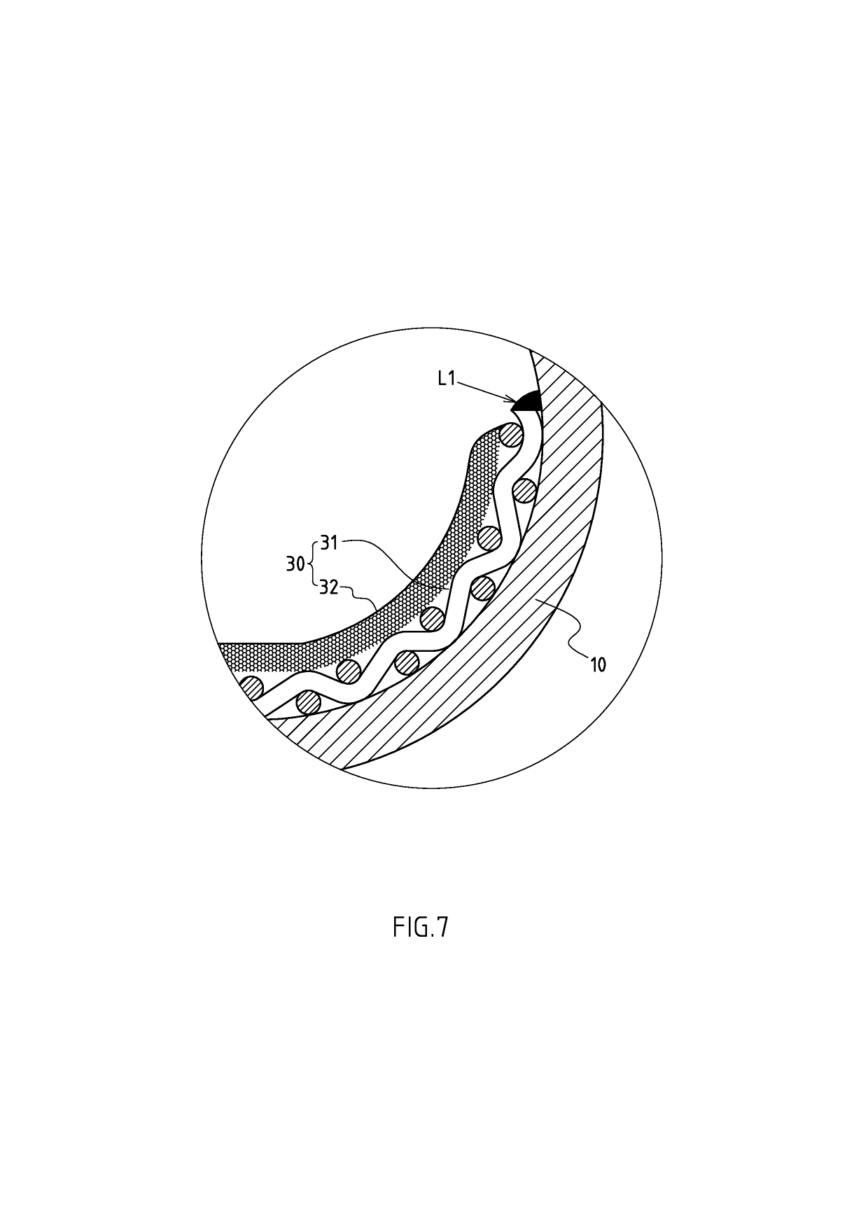

Referring to FIG. 7, the grid-sintered composite capillary structure 30 and the pipe body 10 are fixed by means of sintering (e.g.: sintering position marked by arrow L1).

Of which, the powder limiting grid 50 is individually fabricated and then abutted laterally onto the grid-sintered composite capillary structure 30, or formed by the protruding of the grid-sintered composite capillary structure 30 (e.g.: winged pattern).

Referring to FIG. 1, the evaporation section sintered capillary structure 20 is formed in a way that one end of the grid-sintered composite capillary structure 30 is extended to the evaporation section 12. Said grid-sintered composite capillary structure 30 is of a partially distributed pattern. One side of the evaporation section sintered capillary structure 20 not formed by the extension of grid-sintered composite capillary structure 30 is compensated into a ringed pattern by the filled metal powder 40 (e.g.: copper powder) (shown in FIG. 4), and the powder limiting grid 50 is used as a limiting element of said metal powder 40.

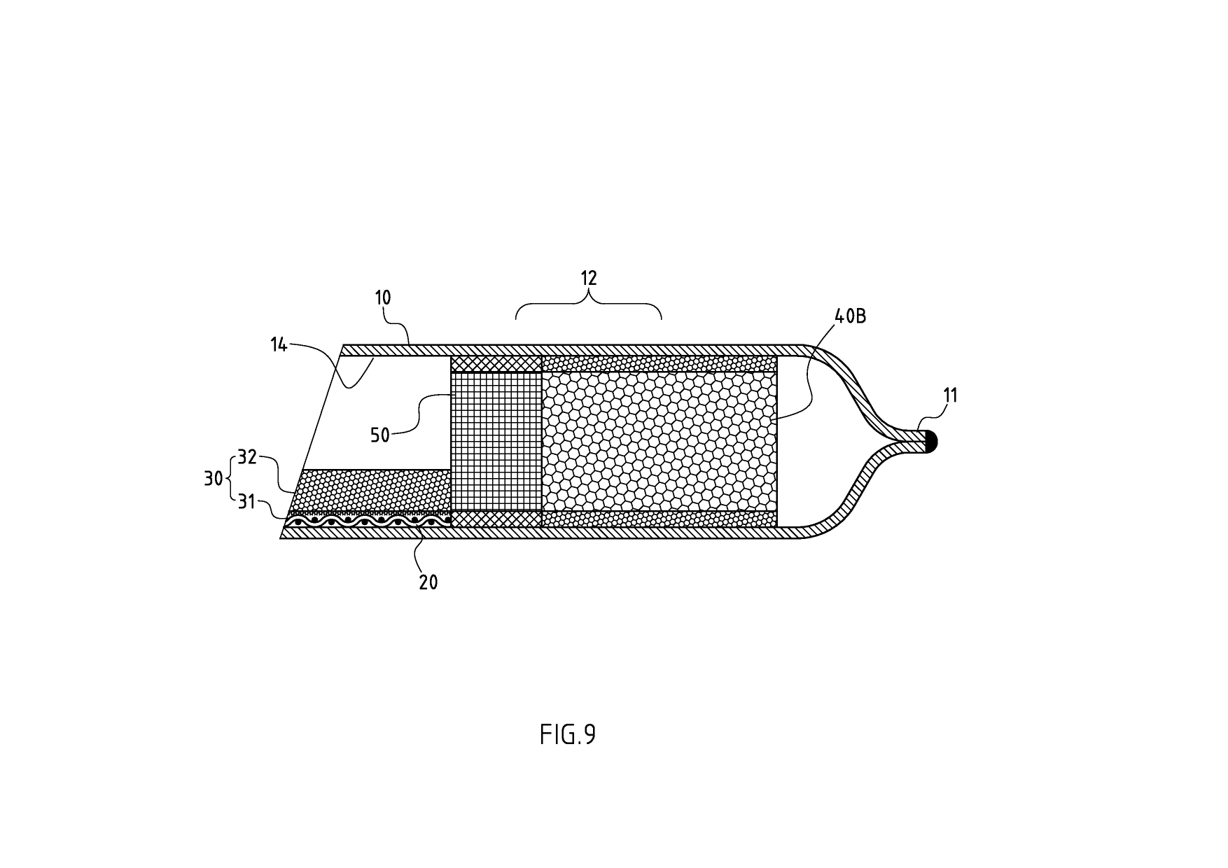

Referring also to FIG. 9, the grid-sintered composite capillary structure 30 is of a partially distributed pattern. The evaporation section sintered capillary structure 20 is fabricated by sintering of the metal powder 40B filled circularly onto the evaporation section 12, and the powder limiting grid 50 is used as a limiting element of said metal powder 40B in the powder filling process.

The core design of the present invention lies in the integrated design of said grid-sintered composite capillary structure 30 and evaporation section sintered capillary structure 20. Of which, the sintered powder layer 32 is pre-sintered onto the surface of the metal grid 31, and then the grid-sintered composite capillary structure 30 is embedded into the pipe body 10, so its cross section can be minimized to increase the sectional space of the steam flow channel 16 of heat pipe. Moreover, due to the flexibility of the grid-sintered composite capillary structure 30, the flexible processing of heat pipe wall can be adapted, such that the a stable mating is maintained between the capillary structure and the wall of the heat pipe A, thus preventing deformation, blocking or jamming of the flow channel due to processing of bent pipe. With the setting of the evaporation section sintered capillary structure 20, it is possible to improve the vaporization efficiency of the working fluid 15 at the evaporation section 12 and the heat-dissipation efficiency of heat pipe A.

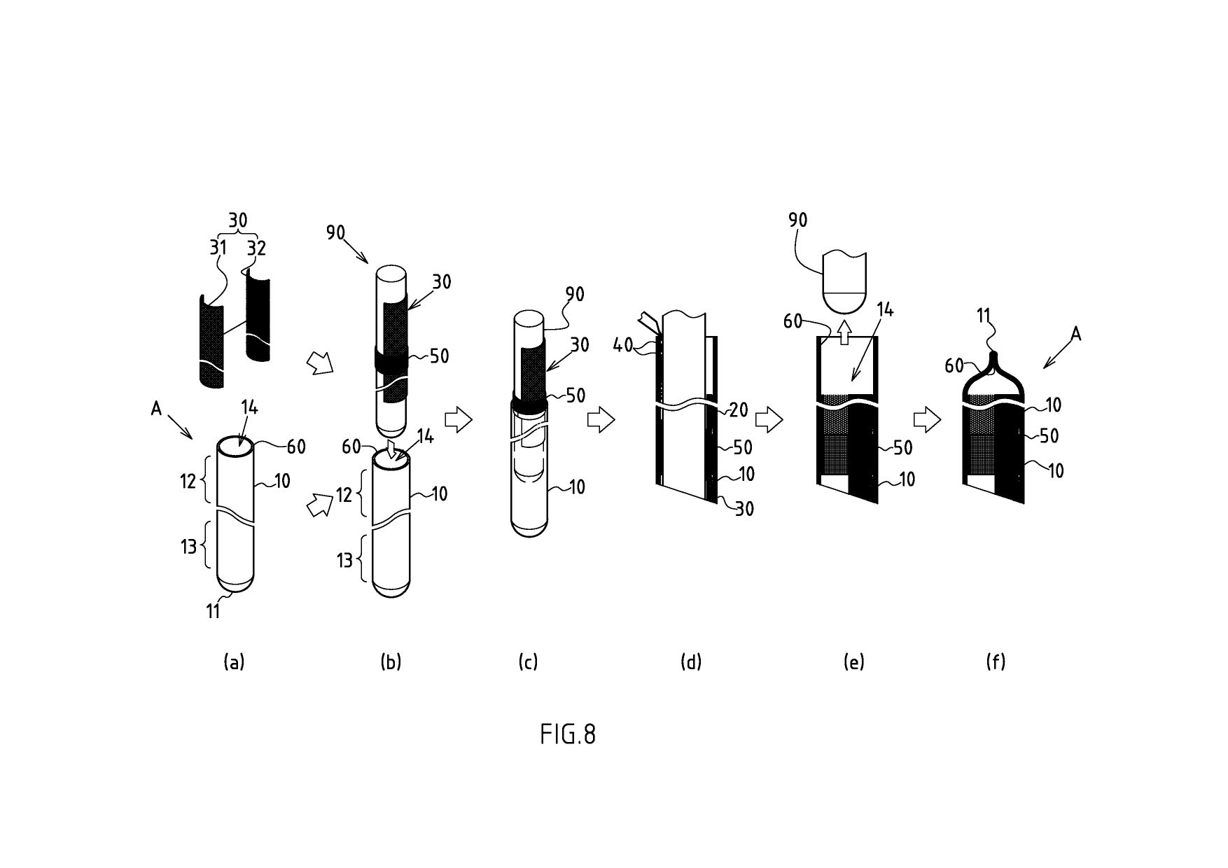

Next, the heat pipe of the present invention for capillary structure with controllable sintering position is fabricated by the following steps: (shown in FIG. 8)

1. as shown in FIG. 8(a), prepare a pipe body 10, then seal one end of the pipe body 10, and set an opening 60 at the other end to connect with the inner space 14 of the pipe body 10;

2. as shown in FIG. 8(a), fabricate a grid-sintered composite capillary structure 30, which is made in a way that sintered powder layers 32 are pre-sintered with the metal powder 40 and formed onto at least a lateral surface of a metal grid 31;

3. as shown in FIG. 8(b), take a core rod 90;

4. as shown in FIG. 8(b), attach the grid-sintered composite capillary structure 30 onto the core rod 90, and abut a powder limiting grid 50 circularly onto the core rod 90, such that the grid-sintered composite capillary structure 30 is affixed securely onto the core rod 90;

5. as shown in FIG. 8(c), insert the core rod 90 into the inner space 14 of the pipe body 10 from the opening 60 of the pipe body 10, such that the grid-sintered composite capillary structure 30 is guided into the inner space 14 of the pipe body 10 simultaneously with the powder limiting grid 50; the grid-sintered composite capillary structure 30 is located at least correspondingly to the preset condensation section 13 of the pipe body 10, and the powder limiting grid 50 located correspondingly to the juncture of the preset condensation section 13 and evaporation section 12 of the pipe body 10;

6. as shown in FIG. 8(d), use the powder limiting grid 50 as the bottom limiter of filled powder, fill the metal powder 40 from the opening 60 of the pipe body 10, and then sinter it into an evaporation section sintered capillary structure 20;

7. as shown in FIG. 8(e), draw out the core rod 90 from the inner space 14 of the pipe body 10;

8. as shown in FIG. 8(f), pour the working fluid into the inner space 14 of the pipe body 10 through the opening 60 of the pipe body 10 and vacuumize it, then seal the opening 60 to form closed ends 11, i.e.: said heat pipe A is fabricated.

1. (canceled)

2. (canceled)

3. (canceled)

4. (canceled)

5. (canceled)

6. (canceled)

7. (canceled)

8. A method of forming a heat pipe comprising:
forming a pipe body having a sealed end and an open end, said pipe body having an inner space, said pipe body having a condensation section and an evaporation section;
fabricating a grid-sintered composite capillary structure such that sintered metal powder is pre-sintered with metal powder and formed onto at least a lateral surface of a metal grid, said grid-sintered composite capillary structure being flexible;
attaching the grid-sintered capillary structure onto a core rod;
placing a powder limiting grid circumferentially onto said core rod such that said grid-sintered composite capillary structure is securely affixed onto said core rod;
inserting said core rod into said inner space of said pipe body through said open end of said pipe body such that said grid-sintered composite capillary structure is guided into said inner space of said pipe body simultaneously with said powder limiting grid, said grid-sintered composite capillary structure being positioned in said condensation section of said pipe body, said powder limiting grid located at a junction of said evaporation section and said condensation section of said pipe body;
introducing a metal powder into said opening of said pipe body in a space between an outer surface of said core rod such that said powder limiting grid acts as a bottom limit of said metal powder;
sintering the metal powder so as to form an sintered capillary structure in said evaporation section;
drawing said core rod from said inner space outwardly through said opening of said core body;
pouring a working fluid into said inner space of said pipe body through the opening of said pipe body; and
sealing the opening of said pipe body.

9. The method of forming a heat pipe of claim 8, said metal powder of said grid-sintered composite capillary structure having a thickness of between 0.1-0.7 millimeters, said grid-sintered composite capillary structure having a total thickness of between 0.2-0.8 millimeters.

10. The method of forming a heat pipe of claim 8, said grid-sintered composite capillary structure being securely sintered to said pipe body.

11. The method of forming a heat pipe of claim 8, said powder limiting grid being abutted laterally onto said grid-sintered composite capillary structure.

12. The method of forming a heat pipe of claim 8, one end of said sintered capillary structure extending into said evaporation section, said grid-sintered composite capillary structure is of a partially distributed pattern.

13. The method of forming a heat pipe of claim 8, the step of introducing comprising:
filling the metal powder circularly into said evaporation section.
